(19) United States
(12) Patent Application Publication
(10) Pub. No.: US 2013/0223412 A1
(43) Pub. Date: Aug. 29, 2013

(54) METHOD AND SYSTEM TO IMPROVE FRAME EARLY TERMINATION SUCCESS RATE

(71) Applicant: QUALCOMM Incorporated, (US)

(72) Inventor: Sharad Deepak SAMBHWANI, San Diego, CA (US)

(73) Assignee: QUALCOMM Incorporated, San Diego, CA (US)

(21) Appl. No.: 13/773,484

(22) Filed: Feb. 21, 2013

Related U.S. Application Data
(60) Provisional application No. 61/603,096, filed on Feb. 24, 2012.

(51) Int. Cl. H04W 72/12

(52) U.S. Cl. CPC H04W 72/12
USPC 370/336; 370/328; 370/329

(57) ABSTRACT

A method, an apparatus, and a computer program product for wireless communication are provided. A transmitting apparatus receives a packet at a MAC layer object and generates a first MAC layer output and at least one duplicate MAC layer output based on the received packet. The MAC layer output and duplicate MAC layer output are fed to a PHY layer object. The PHY layer object can transmit first PHY layer information in a first TTI and begin transmitting a second, duplicate PHY layer information in a second, consecutive TTI following the first TTI. The receiving apparatus receives first information in a first TTI and receives duplicate information in a second, consecutive TTI following the first TTI. The receiving apparatus attempts to early decode the information in the first TTI, and when unsuccessful, attempts to decode the information in the second TTI.

### CLAIM OF PRIORITY UNDER 35 U.S.C. §119

The present application for patent claims priority to Provisional Application No. 61/603,096 entitled “METHOD TO IMPROVE FRAME EARLY TERMINATION SUCCESS RATE OF CIRCUIT SWITCHED VOICE SENT ON R99DCH” filed Feb. 24, 2012, and assigned to the assignee hereof and hereby expressly incorporated by reference herein.

### REFERENCE TO CO-PENDING APPLICATIONS FOR PATENT

The present application for patent is related to co-pending U.S. patent application “Ack Channel Design for Early Termination of R99 Uplink Traffic” having Attorney Docket No. 121588, filed concurrently herewith, assigned to the assignee hereof, and expressly incorporated by reference herein.

The present application for patent is related to International Patent Application No. PCT/CN2012/071676 titled “Ack Channel Design for Early Termination of R99 Downlink Traffic” having Attorney Docket No. 121604, filed on Feb. 27, 2012, and International Patent Application No. PCT/CN2012/071938 titled “Ack Channel Design for Early Termination of R99 Downlink Traffic” having Attorney Docket No. 121698, filed on Mar. 5, 2012, both of which are assigned to the assignee hereof, and both of which are expressly incorporated by reference herein.

### BACKGROUND

1. Field

The present disclosure relates generally to communication systems, and more particularly, to a method, a computer program product, and an apparatus that improve frame early termination success rates.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Substantial system capacity gains and receiver power consumption reductions can be made possible through the use of early decoding. For example, system capacity gains are possible when a transmitter is able to stop a packet transmission as soon as it is made aware that the receiver has succeeded in decoding the packet early. Receiver power consumption savings are also possible because appropriate receiver subsystems can be powered down from the time of successful early decoding until the end of the packet duration. It is important to enable a high probability of success when packets are attempted to be decoded at early instants. Aspects presented herein increase the probability of successful early decoding. Additionally, aspects presented herein apply existing physical layer transmit and receive configurations with modifications apparent at the media access control (MAC) layer and the radio resource control (RRC) layer.

In an aspect of the disclosure, a method, a computer program product, and an apparatus are provided. The apparatus receives a packet at a MAC layer object and generates a first MAC layer output and at least one duplicate MAC layer output based on the received packet. The apparatus feeds the first MAC layer output and the duplicate MAC layer output to a physical (PHY) layer object.

The apparatus can further transmit first PHY layer information based on the first MAC layer output in a first transmission time interval (TTI) and begin a transmission of second PHY layer information based on the duplicate MAC layer output in a second, consecutive TTI following the first TTI.

The transmitted information may comprise circuit switched (CS) voice packets transmitted over an R99 dedicated channel. The first TTI and the second TTI each have a period ½ of a period at which a voice codec generates voice frames.

The information may be transmitted on a dedicated traffic channel (DTCH), the two consecutive transmissions each having a TTI of 10 ms. Alternately, the information may be transmitted on a dedicated control channel (DCCH), the two consecutive transmissions each having a TTI of 20 ms.

In another aspect, the apparatus may cease transmission of the second PHY layer information after receiving an indication of early decoding from a receiver.

In another aspect, the apparatus may process a voice frame at the MAC layer and feed a first output and a duplicate output from the MAC layer to the PHY layer during a duration that is twice the TTI of the PHY layer. The first output may be processed by a PHY layer as the first PHY layer information, and the duplicate output may be processed by the PHY layer as the second PHY layer information.

In another aspect of the disclosure, a method, a computer program product, and an apparatus are provided. The apparatus receives first information in a first TTI. The apparatus then receives duplicate information in a second, consecutive TTI following the first TTI. The apparatus attempts to early decode the information in the first TTI. When the information in the first TTI has not been successfully decoded, the apparatus attempts to decode the information in the second TTI.

The first information may be first PHY layer information and the second information may be second MAC layer information. The received information may comprise CS voice packets transmitted over an R99 dedicated channel. The first TTI and the second TTI may each have a period ½ of a period at which a voice codec generates voice frames. The information may be received on a DTCH, the two consecutive transmissions each having a TTI of 10 ms. The information may be transmitted on a DCCH, the two consecutive transmissions each having a TTI of 20 ms.

The apparatus may cease decoding when either the first information or the second information is successfully decoded. The apparatus may transmit an indication that the information has been successfully decoded prior to receiving the entire duplicate information.

In order to attempt to decode second PHY layer information in the second TTI layer, when PHY layer information in the first TTI has not been successfully decoded, the apparatus may soft combine symbols across the two consecutive TTIs.

The apparatus may update a signal to interference ration (SIR) target when a packet has been decoded successfully or when a packet has not been decoded at the end of the second TTI. When the PHY layer information is decoded successfully, the SIR target may be reduced by a fixed step size. The SIR target may be increased by a step size, when the packet fails to decode in the first TTI and the second TTI.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a diagram illustrating an example of a hardware implementation for an apparatus employing a processing system.

FIG. 2 is a block diagram conceptually illustrating an example of a telecommunications system.

FIG. 3 is a conceptual diagram illustrating an example of an access network.

FIG. 4 is a block diagram conceptually illustrating an example of a Node B in communication with a UE in a telecommunications system.

FIG. 5 is a diagram illustrating an example of a radio protocol architecture for the user and control planes.

FIG. 6 is a diagram illustrating a method of repeating CS voice frames (sent on the DTCH) at the MAC layer using 10 ms TTI.

FIG. 7 is a diagram illustrating a method of Repeating DCCH at MAC layer using 20 ms TTI.

FIG. 8 illustrates cumulative success rates due to Early Decoding of AMR Full Rate Frames mapped to 20 ms TTI applying a legacy methodology.

FIG. 9 illustrates cumulative success rates due to Early Decoding of AMR Full Rate Frames with proposed method applying TTI reduction and MAC layer repetition.

FIG. 10 is a flow chart of a method of wireless communication.

FIG. 11 is a flow chart of a method of wireless communication

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

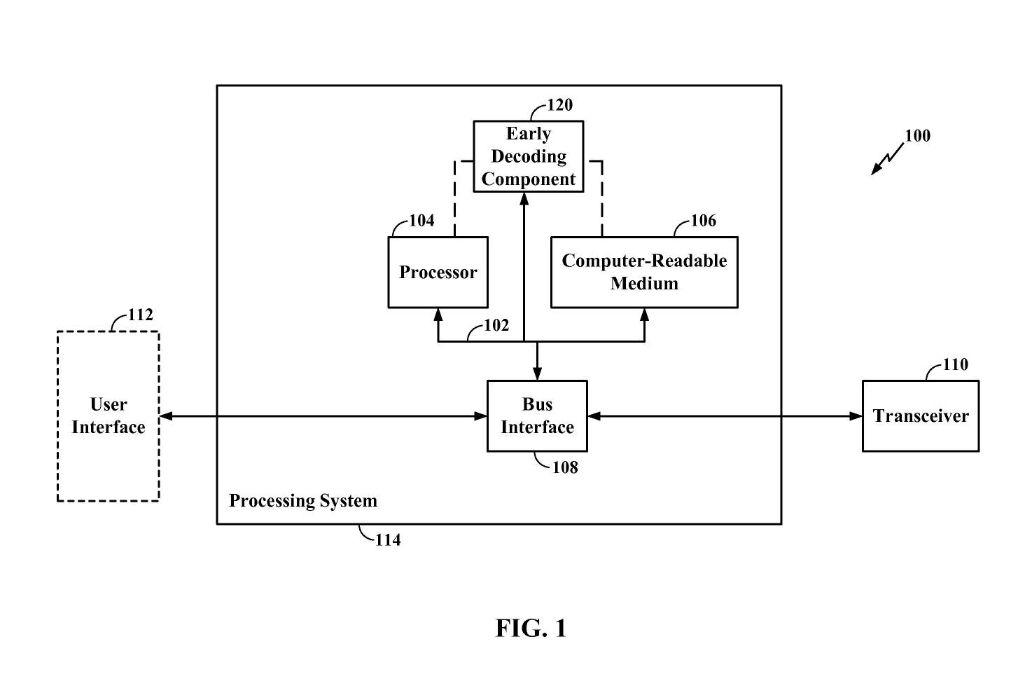

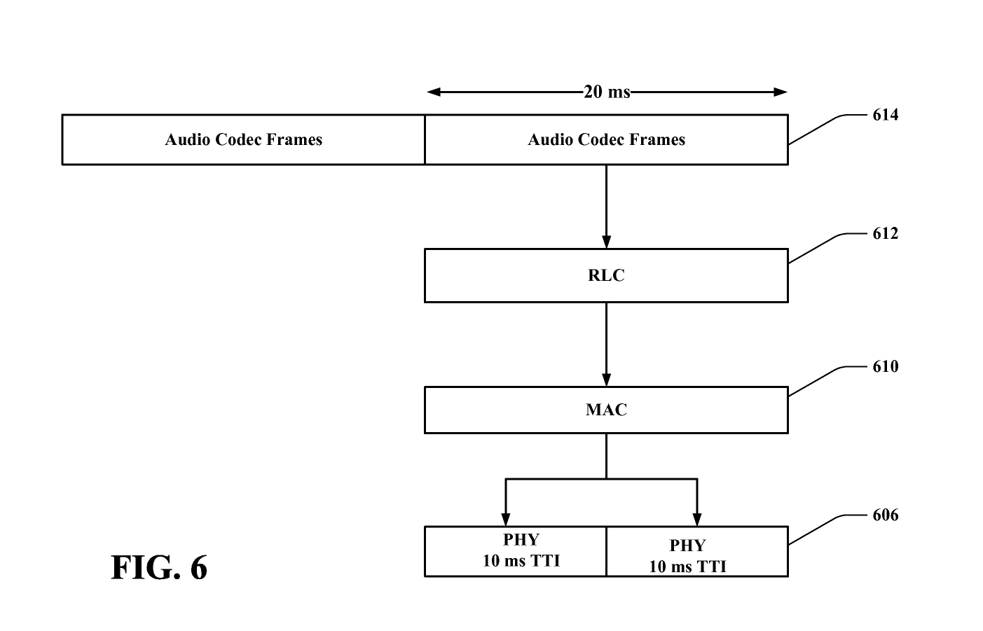

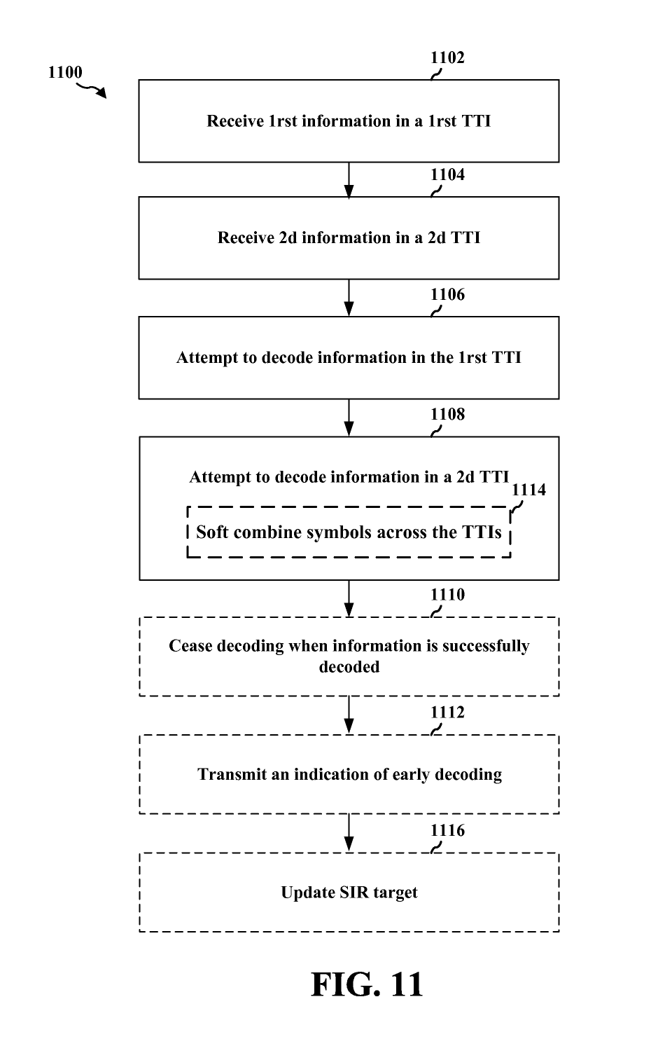

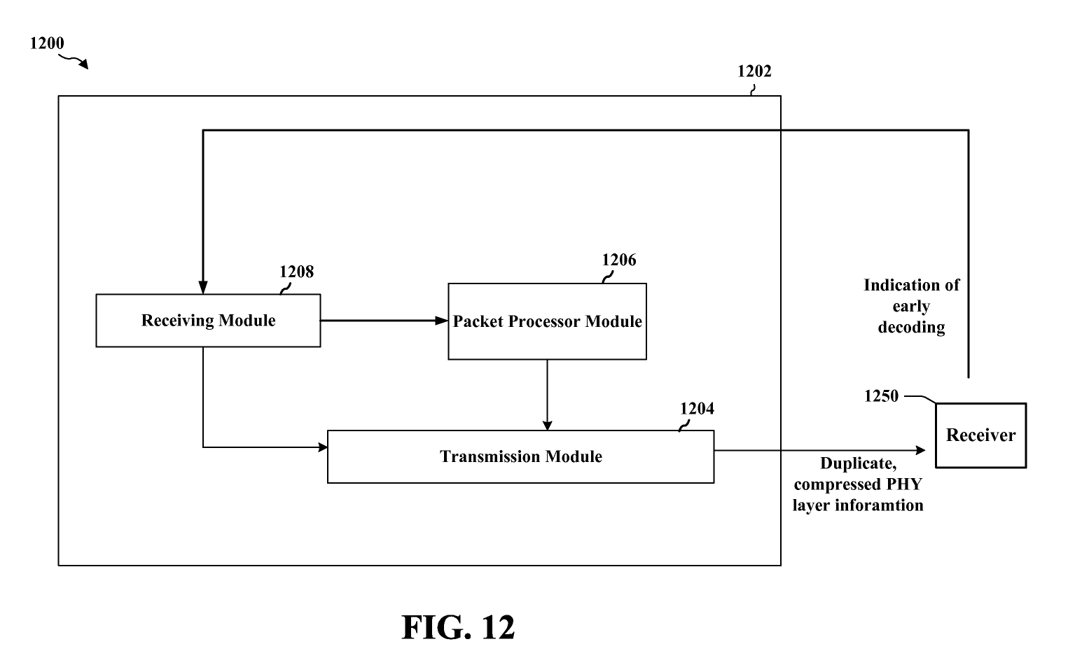

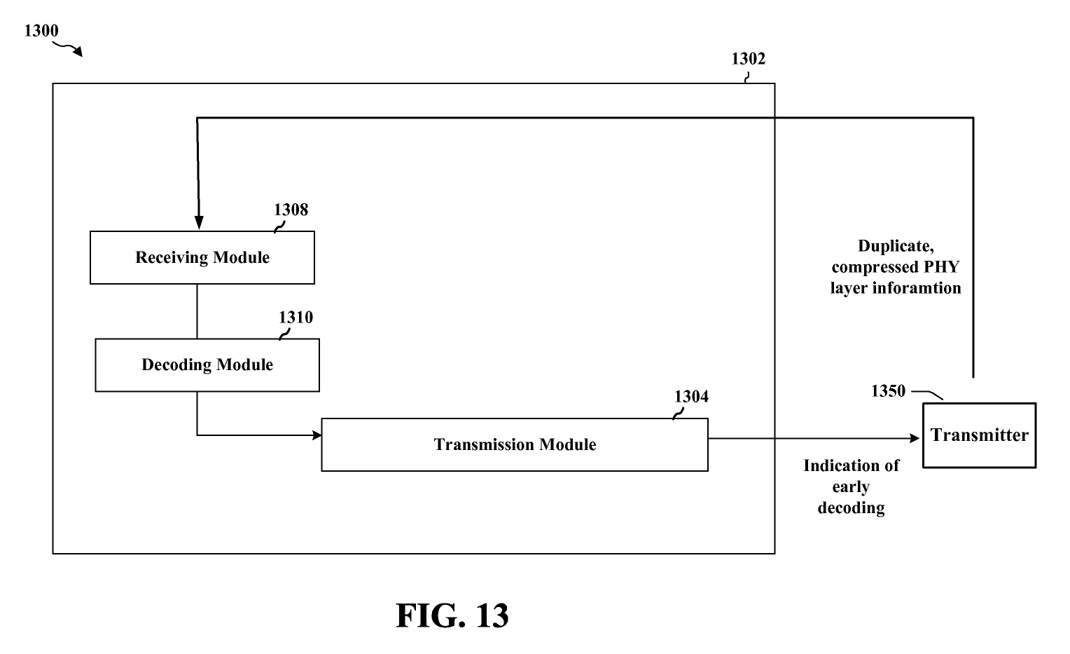

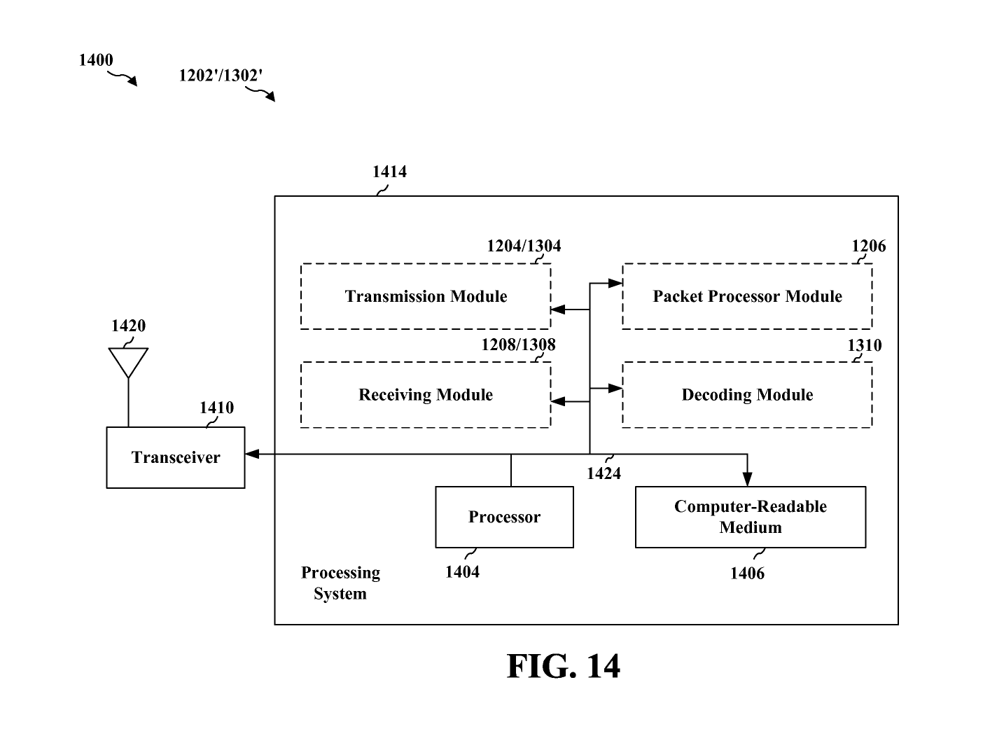

FIG. 1 is a conceptual diagram illustrating an example of a hardware implementation for an apparatus 100 employing a processing system 114. The processing system 114 may further include an early decoding component 120 that is configured to process and transmit and to receive physical (PHY) layer information. For example, the early decoding component may include transmission functions similar to those described in connection with FIGS. 6, 7, and 10, and reception and early decoding functions similar to those described in connection with FIG. 11. In some aspects, early decoding component 120 may be a stand-alone component within processing system 114, or may be defined by one or more processing modules within processor 104, or by executable code or instructions stored as computer-readable medium 106 and executable by processor 104, or some combination thereof.

For example, aspects of the transmission function of the early decoding component 120 may transmit first PHY layer information in a first TTI and begin a transmission of second PHY layer information in a second, consecutive TTI following the first TTI. The second PHY layer information is a duplicate of the first PHY layer information, and the first and second TTI each have a period that is one half of a period at which a voice codec generates voice frames. By sending the duplicate information during two TTIs have a shortened period, increases the success rate of early decoding.

Aspects of the reception function of the early decoding component 120 may include receiving first PHY layer information in a first TTI and receiving duplicate PHY layer information in a second, consecutive TTI following the first TTI. The second PHY layer information is a duplicate of the first PHY layer information, and the first TTI and the second TTI each have a period ½ of a period at which a voice codec generates voice frames. The reception function attempts to early decode the PHY layer information in the first TTI, and attempts to decode the PHY layer information in the second TTI, when the PHY layer information in the first TTI has not been successfully decoded. When the PHY layer information in the first TTI has been successfully decoded, the reception function ceases decoding. The reception function may also trigger an indication to the transmitter transmitting the PHY layer information, the notification indicating that the transmission has been early decoded.

In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104, and computer-readable media, represented generally by the computer-readable medium 106. The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick) may also be provided.

The processor 104 is responsible for managing the bus 102 and general processing, including the execution of software stored on the computer-readable medium 106. In one aspect, the software stored on the computer-readable medium 106 may include instructions defining early decoding component 120, which when executed by the processor 104, causes the processing system 114 to perform the various functions described infra for any particular apparatus. The computer-readable medium 106 may also be used for storing data that is manipulated by the processor 104 when executing software. In another aspect, processor 104 may include one or more processor modules defining early decoding component 120, such that execution of the processor 104 causes the processing system 114 to perform the various functions described infra for any particular apparatus.

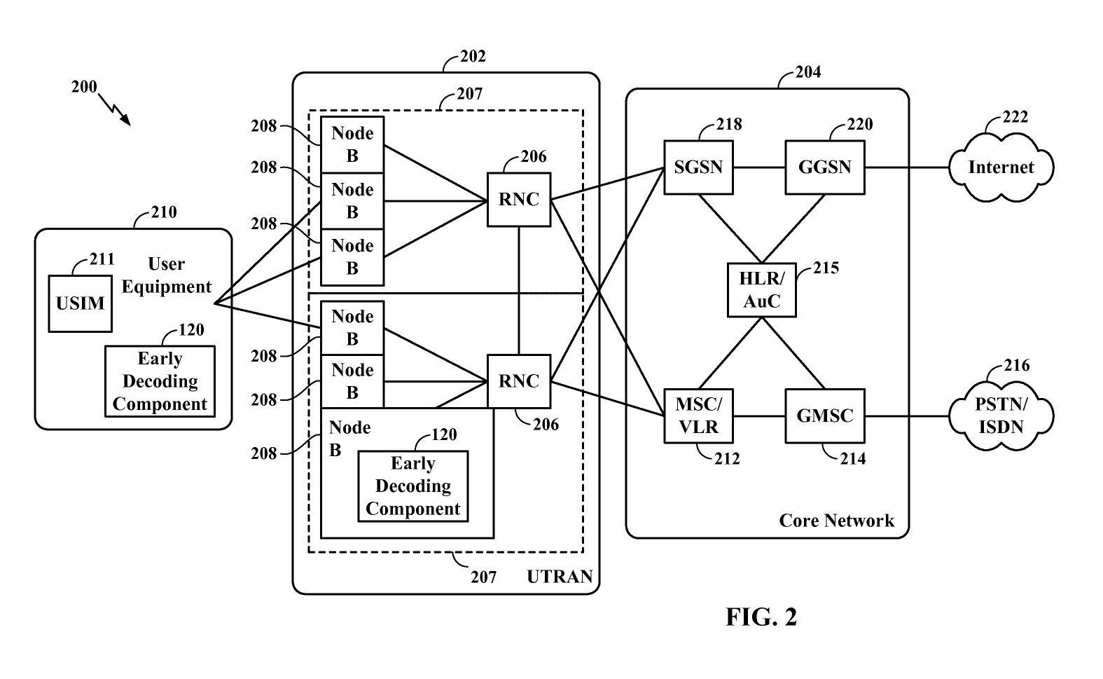

The various concepts presented throughout this disclosure may be implemented across a broad variety of telecommunication systems, network architectures, and communication standards. By way of example and without limitation, the aspects of the present disclosure relating to early decoding component 120 of FIG. 1 and further illustrated in FIG. 2 are operated by User Equipment (UE) 210 and/or Node B 208 in a UMTS system 200 employing a W-CDMA air interface. UMTS system 200 includes three interacting domains: a Core Network (CN) 204, a UMTS Terrestrial Radio Access Network (UTRAN) 202, and UE 210. In this example, the UTRAN 202 provides various wireless services including telephony, video, data, messaging, broadcasts, and/or other services. The UTRAN 202 may include a plurality of Radio Network Subsystems (RNSs) such as an RNS 207, each controlled by a respective Radio Network Controller (RNC) such as an RNC 206. Here, the UTRAN 202 may include any number of RNCs 206 and RNSs 207 in addition to the RNCs 206 and RNSs 207 illustrated herein. The RNC 206 is an apparatus responsible for, among other things, assigning, reconfiguring and releasing radio resources within the RNS 207. The RNC 206 may be interconnected to other RNCs (not shown) in the UTRAN 202 through various types of interfaces such as a direct physical connection, a virtual network, or the like, using any suitable transport network.

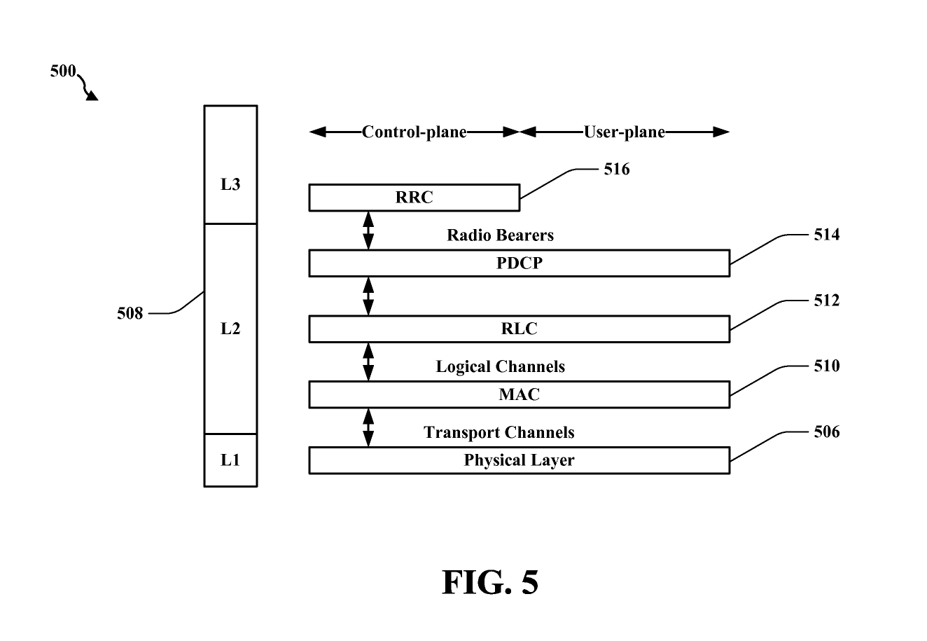

Communication between a UE 210 and a Node B 208 may be considered as including a physical (PHY) layer and a medium access control (MAC) layer, as described in further detail in connection with FIGS. 5-7. Further, communication between a UE 210 and an RNC 206 by way of a respective Node B 208 may be considered as including a radio resource control (RRC) layer. In the instant specification, the PHY layer may be considered layer 1; the MAC layer may be considered layer 2; and the RRC layer may be considered layer 3. Information hereinbelow utilizes terminology introduced in Radio Resource Control (RRC) Protocol Specification, 3GPP TS 25.331 v9.1.0, incorporated herein by reference.

The geographic region covered by the SRNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in each SRNS 207; however, the SRNSs 207 may include any number of wireless Node Bs. The Node Bs 208 provide wireless access points to a core network (CN) 204 for any number of mobile apparatuses. Although only one Node B is illustrated as having an early decoding component 120, as described in connection with FIG. 1, each of the Node Bs 120 may include such a component. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. In a UMTS system, the UE 210 may further include a universal subscriber identity module (USIM) 211, which contains a user's subscription information to a network. For illustrative purposes, one UE 210 is shown in communication with a number of the Node Bs 208. The downlink (DL), also called the forward link, refers to the communication link from a Node B 208 to a UE 210, and the uplink (UL), also called the reverse link, refers to the communication link from a UE 210 to a Node B 208.

The core network 204 interfaces with one or more access networks, such as the UTRAN 202. As shown, the core network 204 is a GSM core network. However, as those skilled in the art will recognize, the various concepts presented throughout this disclosure may be implemented in a RAN, or other suitable access network, to provide UEs with access to types of core networks other than GSM networks.

The core network 204 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the core network 204 supports circuit-switched services with a MSC 212 and a GMSC 214. In some applications, the GMSC 214 may be referred to as a media gateway (MGW). One or more RNCs, such as the RNC 206, may be connected to the MSC 212. The MSC 212 is an apparatus that controls call setup, call routing, and UE mobility functions. The MSC 212 also includes a visitor location register (VLR) that contains subscriber-related information for the duration that a UE is in the coverage area of the MSC 212. The GMSC 214 provides a gateway through the MSC 212 for the UE to access a circuit-switched network 216. The core network 204 includes a home location register (HLR) 215 containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR 215 to determine the UE's location and forwards the call to the particular MSC serving that location.

The core network 204 also supports packet-data services with a serving GPRS support node (SGSN) 218 and a gateway GPRS support node (GGSN) 220. GPRS, which stands for General Packet Radio Service, is designed to provide packet-data services at speeds higher than those available with standard circuit-switched data services. The GGSN 220 provides a connection for the UTRAN 202 to a packet-based network 222. The packet-based network 222 may be the Internet, a private data network, or some other suitable packet-based network. The primary function of the GGSN 220 is to provide the UEs 210 with packet-based network connectivity. Data packets may be transferred between the GGSN 220 and the UEs 210 through the SGSN 218, which performs primarily the same functions in the packet-based domain as the MSC 212 performs in the circuit-switched domain.

The UMTS air interface is a spread spectrum Direct-Sequence Code Division Multiple Access (DS-CDMA) system. The spread spectrum DS-CDMA spreads user data through multiplication by a sequence of pseudorandom bits called chips. The W-CDMA air interface for UMTS is based on such direct sequence spread spectrum technology and additionally calls for a frequency division duplexing (FDD). FDD uses a different carrier frequency for the uplink (UL) and downlink (DL) between a Node B 208 and a UE 210. Another air interface for UMTS that utilizes DS-CDMA, and uses time division duplexing, is the TD-SCDMA air interface. Those skilled in the art will recognize that although various examples described herein may refer to a WCDMA air interface, the underlying principles are equally applicable to a TD-SCDMA air interface.

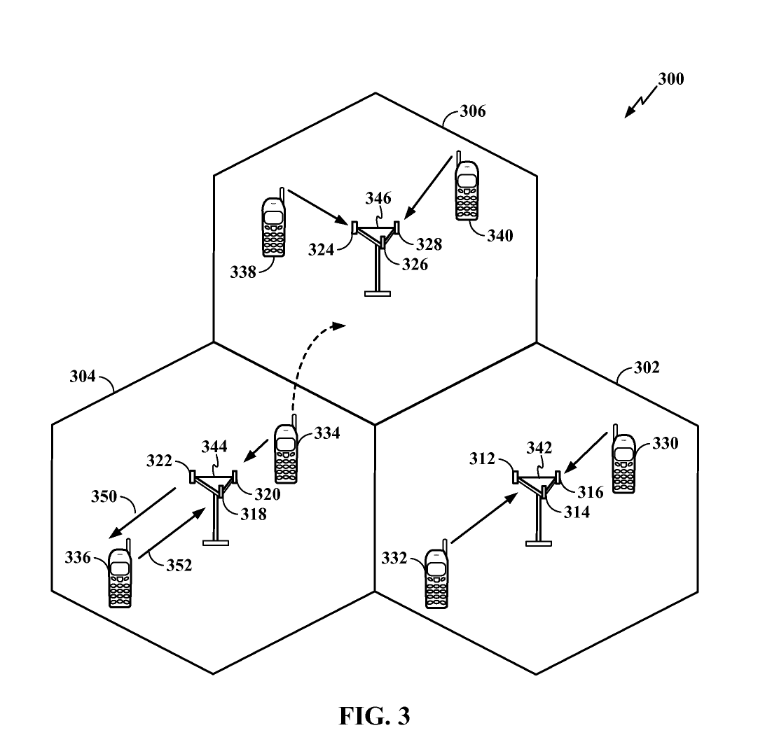

Referring to FIG. 3, an access network 300 in a UTRAN architecture is illustrated. The multiple access wireless communication system includes multiple cellular regions (cells), including cells 302, 304, and 306, each of which may include one or more sectors. Aspects of early decoding, as described in connection with FIGS. 6, 7, 10, and 11, including early decoding component 112 of FIG. 1, may be employed in communication between UEs 330, 332, 334, 336, 338, and 340 and cells 302, 304, and 306. For example, a UE 336 may receive a packet transmission 350 from transmitter 344. The UE may attempt to early decode the packet transmission 350 prior to receive the entire packet transmission 350. Once the UE has successfully early decoded the packet transmission, the UE may transmit an indication 352 to the transmitter 344. This enables the transmitter to cease transmission of the packet transmission, thereby providing system capacity gains.

The multiple sectors can be formed by groups of antennas with each antenna responsible for communication with UEs in a portion of the cell. For example, in cell 302, antenna groups 312, 314, and 316 may each correspond to a different sector. In cell 304, antenna groups 318, 320, and 322 each correspond to a different sector. In cell 306, antenna groups 324, 326, and 328 each correspond to a different sector. The cells 302, 304 and 306 may include several wireless communication devices, e.g., User Equipment or UEs, which may be in communication with one or more sectors of each cell 302, 304 or 306. For example, UEs 330 and 332 may be in communication with Node B 342, UEs 334 and 336 may be in communication with Node B 344, and UEs 338 and 340 can be in communication with Node B 346. Here, each Node B 342, 344, 346 is configured to provide an access point to a core network 204 (see FIG. 2) for all the UEs 330, 332, 334, 336, 338, 340 in the respective cells 302, 304, and 306.

As the UE 334 moves from the illustrated location in cell 304 into cell 306, a serving cell change (SCC) or handover may occur in which communication with the UE 334 transitions from the cell 304, which may be referred to as the source cell, to cell 306, which may be referred to as the target cell. Management of the handover procedure may take place at the UE 334, at the Node Bs corresponding to the respective cells, at a radio network controller 206 (see FIG. 2), or at another suitable node in the wireless network. For example, during a call with the source cell 304, or at any other time, the UE 334 may monitor various parameters of the source cell 304 as well as various parameters of neighboring cells such as cells 306 and 302. Further, depending on the quality of these parameters, the UE 334 may maintain communication with one or more of the neighboring cells. During this time, the UE 334 may maintain an Active Set, that is, a list of cells that the UE 334 is simultaneously connected to (i.e., the UTRA cells that are currently assigning a downlink dedicated physical channel DPCH or fractional downlink dedicated physical channel F-DPCH to the UE 334 may constitute the Active Set).

The modulation and multiple access scheme employed by the access network 300 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

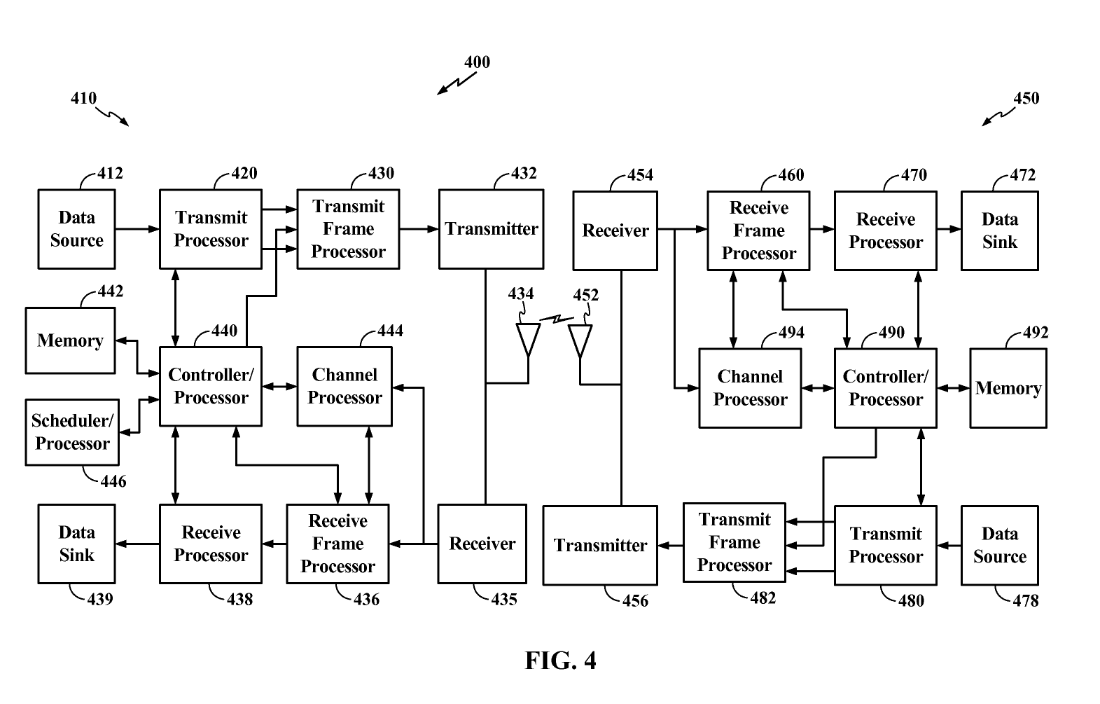

FIG. 4 is a block diagram of a Node B 410 in communication with a UE 450, where the Node B 410 may be the Node B 208 in FIG. 2, and the UE 450 may be the UE 210 in FIG. 2. As described herein, in Node B 410, the transmission function of early decoding component 120 of FIGS. 1 and 2, may include any or the TX Processor 420, the TX Frame Processor, and the controller/processor 440. The reception function of the early decoding component of Node B 410 may include any of the RX Processor 438, the RX Frame Processor, and the controller/processor 440. In UE 450, the transmission function of the early decoding component 120 of FIGS. 1 and 2 may include any of the TX Processor 480, the Transmit Frame Processor 482, and Controller/processor 490. The reception function of the early decoding component 120 in UE 450 may include any of the RX Processor 470, the RX Frame Processor 460, and the controller/processor 490.

In the downlink communication, a transmit processor 420 may receive data from a data source 412 and control signals from a controller/processor 440. The transmit processor 420 provides various signal processing functions for the data and control signals, as well as reference signals (e.g., pilot signals). For example, the transmit processor 420 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 444 may be used by a controller/processor 440 to determine the coding, modulation, spreading, and/or scrambling schemes for the transmit processor 420. These channel estimates may be derived from a reference signal transmitted by the UE 450 or from feedback from the UE 450. The symbols generated by the transmit processor 420 are provided to a transmit frame processor 430 to create a frame structure. The transmit frame processor 430 creates this frame structure by multiplexing the symbols with information from the controller/processor 440, resulting in a series of frames. The frames are then provided to a transmitter 432, which provides various signal conditioning functions including amplifying, filtering, and modulating the frames onto a carrier for downlink transmission over the wireless medium through antenna 434. The antenna 434 may include one or more antennas, for example, including beam steering bidirectional adaptive antenna arrays or other similar beam technologies.

At the UE 450, a receiver 454 receives the downlink transmission through an antenna 452 and processes the transmission to recover the information modulated onto the carrier. The information recovered by the receiver 454 is provided to a receive frame processor 460, which parses each frame, and provides information from the frames to a channel processor 494 and the data, control, and reference signals to a receive processor 470. The receive processor 470 then performs the inverse of the processing performed by the transmit processor 420 in the Node B 410. More specifically, the receive processor 470 descrambles and despreads the symbols, and then determines the most likely signal constellation points transmitted by the Node B 410 based on the modulation scheme. These soft decisions may be based on channel estimates computed by the channel processor 494. The soft decisions are then decoded and deinterleaved to recover the data, control, and reference signals. The CRC codes are then checked to determine whether the frames were successfully decoded. The data carried by the successfully decoded frames will then be provided to a data sink 472, which represents applications running in the UE 450 and/or various user interfaces (e.g., display). Control signals carried by successfully decoded frames will be provided to a controller/processor 490. When frames are unsuccessfully decoded by the receiver processor 470, the controller/processor 490 may also use an acknowledgement (ACK) and/or negative acknowledgement (NACK) protocol to support retransmission requests for those frames.

In the uplink, data from a data source 478 and control signals from the controller/processor 490 are provided to a transmit processor 480. The data source 478 may represent applications running in the UE 450 and various user interfaces (e.g., keyboard). Similar to the functionality described in connection with the downlink transmission by the Node B 410, the transmit processor 480 provides various signal processing functions including CRC codes, coding and interleaving to facilitate FEC, mapping to signal constellations, spreading with OVSFs, and scrambling to produce a series of symbols. Channel estimates, derived by the channel processor 494 from a reference signal transmitted by the Node B 410 or from feedback contained in the midamble transmitted by the Node B 410, may be used to select the appropriate coding, modulation, spreading, and/or scrambling schemes. The symbols produced by the transmit processor 480 will be provided to a transmit frame processor 482 to create a frame structure. The transmit frame processor 482 creates this frame structure by multiplexing the symbols with information from the controller/processor 490, resulting in a series of frames. The frames are then provided to a transmitter 456, which provides various signal conditioning functions including amplification, filtering, and modulating the frames onto a carrier for uplink transmission over the wireless medium through the antenna 452.

The uplink transmission is processed at the Node B 410 in a manner similar to that described in connection with the receiver function at the UE 450. A receiver 435 receives the uplink transmission through the antenna 434 and processes the transmission to recover the information modulated onto the carrier. The information recovered by the receiver 435 is provided to a receive frame processor 436, which parses each frame, and provides information from the frames to the channel processor 444 and the data, control, and reference signals to a receive processor 438. The receive processor 438 performs the inverse of the processing performed by the transmit processor 480 in the UE 450. The data and control signals carried by the successfully decoded frames may then be provided to a data sink 439 and the controller/processor, respectively. If some of the frames were unsuccessfully decoded by the receive processor, the controller/processor 440 may also use an acknowledgement (ACK) and/or negative acknowledgement (NACK) protocol to support retransmission requests for those frames.

The controller/processors 440 and 490 may be used to direct the operation at the Node B 410 and the UE 450, respectively. For example, the controller/processors 440 and 490 may provide various functions including timing, peripheral interfaces, voltage regulation, power management, and other control functions. The computer readable media of memories 442 and 492 may store data and software for the Node B 410 and the UE 450, respectively. A scheduler/processor 446 at the Node B 410 may be used to allocate resources to the UEs and schedule downlink and/or uplink transmissions for the UEs.

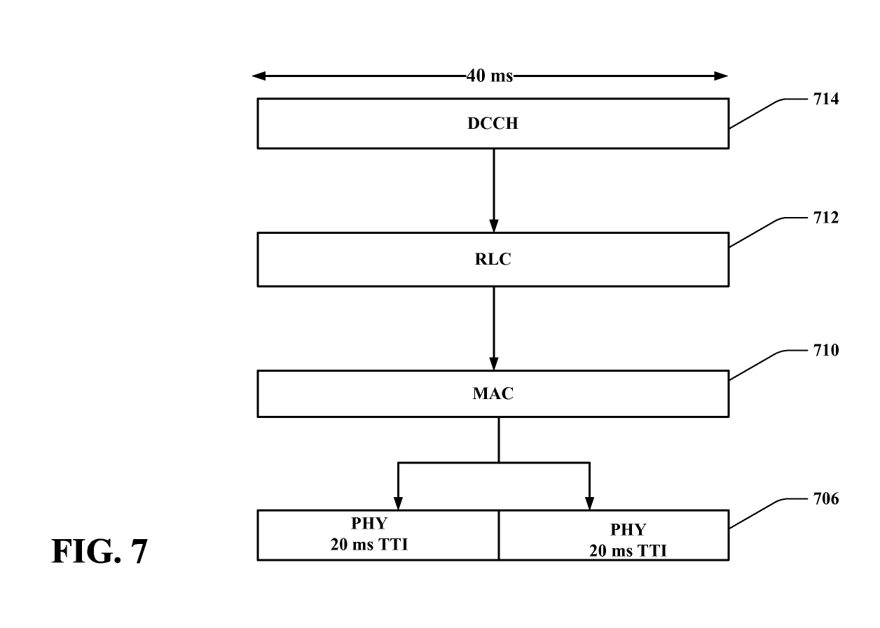

FIG. 5 is a diagram 500 illustrating an example of a radio protocol architecture for the user and control planes in LTE that can be applied, as illustrated in FIGS. 6 and 7 in order to provide duplicate, compressed PHY layer transmissions that increase the success rate of early decoding at a receiver. The radio protocol architecture for the UE and the Node B is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and Node B over the physical layer 506.

In the user plane, the L2 layer 508 includes a MAC sublayer 510, a radio link control (RLC) sublayer 512, and a packet data convergence protocol (PDCP) 514 sublayer, which are terminated at the Node B on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between Node Bs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and Node B is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the Node B and the UE.

In order to provide an opportunity for early decoding, the MAC layer, after processing a voice frame, may feed its output to the PHY layer twice during the same period. Examples of such duplicate transmission are illustrated in FIGS. 6 and 7.

Substantial system capacity gains are possible if a transmitter stops packet transmission as soon as it is made aware that the receiver has succeeded in decoding the packet. Receiver power consumption savings are also possible because appropriate receiver subsystems can be powered down from the time of successful early decoding until the end of the packet duration. Therefore, it is important to enable a high probability of success when packets are attempted to be decoded at earlier instants. Aspects proposed in International Application No. PCT/CN2009/075179 (WO2011/063569) entitled “Increasing Capacity in Wireless Communications,” the entire contents of which are hereby incorporated by reference herein, tried to achieve this goal. However the aspects presented therein require a change in physical layer transmit processing while maintaining the same TTI, e.g., 20 ms for the DTCH, at the physical layer as the voice codec packet duration, e.g., a voice packet is transmitted every 20 ms.

Aspects presented herein overcome this problem by providing a solution where existing physical layer transmit and receive configurations can be reused and modifications become apparent at the L2 layer, e.g., MAC/RRC.

For example, existing physical layer transmit and receive configurations can be reused while significantly improving the early termination success rate of circuit switched voice packets transmitted over an R99 dedicated channel (DCH). This concept may be applied to either downlink or uplink or both.

FIGS. 6 and 7 illustrate the basic concept for DTCH and DCCH, respectively. FIG. 6 illustrates CS voice frames sent on a DTCH at a MAC layer using 10 ms TTI. In FIG. 6, voice frames 614 continue to be generated at the audio codec output every 20 ms and are passed onto the RLC 612, MAC 610, and PHY 606 layers. The PHY layer 606 is configured on a 1 0 ms TTI, instead of the 20 ms TTI corresponding to the audio codec. The MAC layer 610, after processing the voice frame 614, feeds an output to the PHY layer 606 twice during the 20 ms duration. The first instance of the MAC layer output is processed and transmitted by the PHY over a 10 ms TTI duration and the second instance of the MAC layer output is processed and transmitted again in the next 10 ms TTI, the second instance being a duplicate of the first instance. With such a configuration, the repetition process at the MAC layer can remain transparent to the physical layer transmitter. As the packet is compressed in time, e.g., from 20 ms to 10 ms, existing rate matching algorithms, as specified in 3GPP specifications (25.212) with appropriate parameters, can be reused to ensure that the code rate remains the same. This also results in a reduction of the spreading factor by half as achieved in International Application No. PCT/CN2009/075179.

A similar concept applies to DCCH which is time division multiplexed with the DTCH. FIG. 7 illustrates CS voice frames sent on a DCCH using a 20 ms TTI. A DCCH is typically generated at 40 ms instants. Thus, in FIG. 7, the PHY layer 706 is configured on a 20 ms TTI, e.g., half of the 40 ms TTI for the audio codec frames 714 that are processed and passed to the RLC 712 and MAC 710. Processing at the transmitter is similar to the DTCH described in FIG. 6.

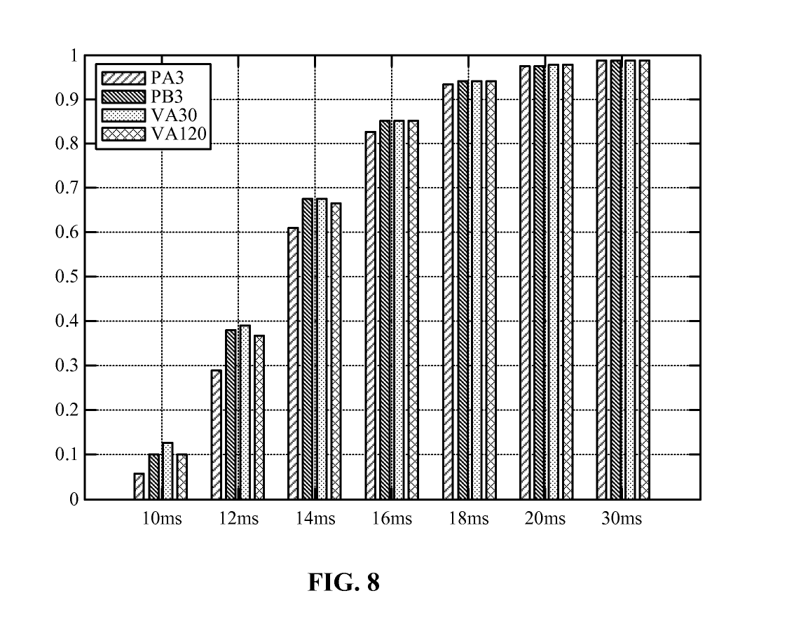

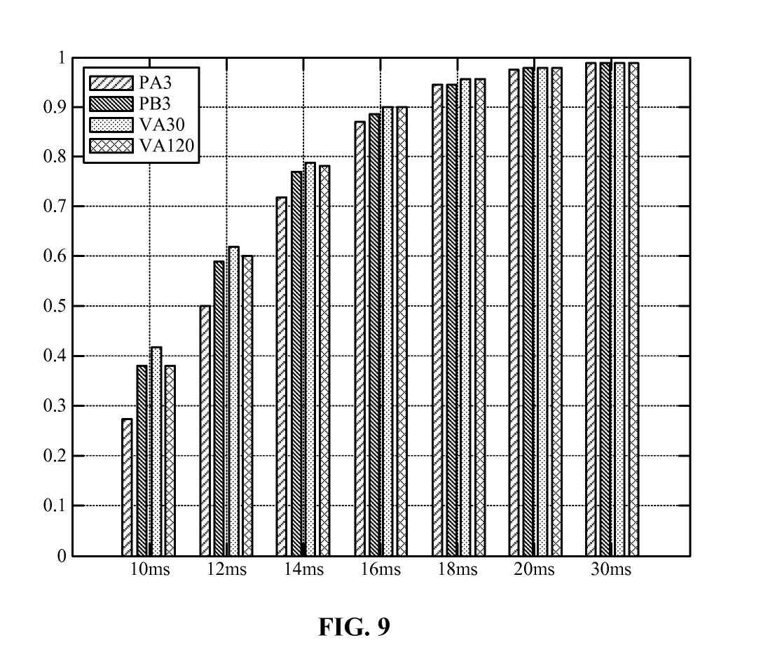

Due to the new TTI configuration having a period half that of a period for the audio codec frames and the repetition process at the MAC layer, a receiver can benefit from a higher success rate at early decoding attempts. FIGS. 8 and 9 illustrate the gain achieved by transmitting two consecutive PHY layers having duplicate data. FIG. 8 illustrates a cumulative success rate of early decoding attempts when the receiver attempts to decode Adaptive Multi-Rate (AMR) Full rate frames transmitted on the legacy uplink waveform. FIG. 9 illustrates the same metric for early decoding attempts when duplicate PHY layer information is transmitted in consecutive TTIs, the TTIs having a period half that of a period for the audio codec frames, as illustrated in connection with FIGS. 6 and 7. As seen in FIGS. 8 and 9, the success rate increases significantly at the earlier decoding instances. For example, the success rate increases from approximately 10% to approximately 40% for decoding attempts at the 10 ms decoding instant.

In addition to the MAC repetition, in order to avoid an increase in transmitted power due to the reduced spreading factor, demodulator processing may be modified at the receiver. For example, the receiver may attempt to demodulate early decode a packet at early instants in each of the two consecutive TTIs that it receives. When the receive fails to decode the packet at the end of the first TTI, the receiver may perform soft combining across the symbols from the first TTI and the second TTI prior to decoding. When the packet decodes successfully, whether in the first TTI or the second TTI, the SIR target can be reduced by a fixed step size. The SIR target may be increased by a step size when the packet fails to decode in either of the two TTIs.

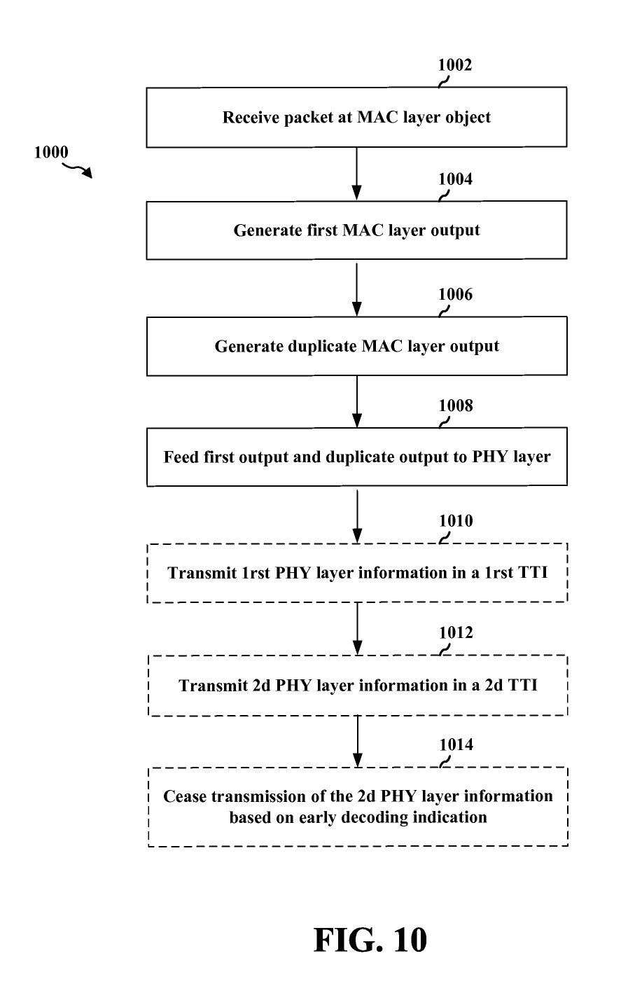

FIG. 10 is a flow chart 1000 of a method of wireless communication. The method may be performed by wireless communication device such as a Node B or a UE, e.g., apparatus 1202 or 1400 in FIGS. 12 and 14, respectively. At 1002, the device receives a packet at a MAC layer object. In an aspect, the reception may be performed, e.g., by a receiving module, e.g., 1208 in FIGS. 12 and 14.

At 1004, the device generates a first MAC layer output based on the received packet, and at 1006, the device generates at least one duplicate MAC layer output based on the received packet. In an aspect, the generation may be performed by a MAC output generator, e.g., packet processor module 1206 in FIGS. 12 and 14.

At 1008, the device feeds the first MAC layer output and the duplicate MAC layer output to a PHY layer object. In an aspect, this feeding may be performed by packet processor module, e.g., 1206 in FIGS. 12 and 14.

The device may optionally transmit first PHY layer information based on the first MAC layer output in a first TTI at 1010. Optional aspects are illustrated with a dashed line. At 1012, the device may begin a transmission of second PHY layer information based on the duplicate MAC layer output in a second, consecutive TTI following the first TTI. Examples of duplicate MAC layer output and TTIs are illustrated in connection with FIGS. 6 and 7. For example, the packet may comprise a voice packet, and the first TTI and the second TTI may each have a period ½ of a period at which a voice codec generates voice frames, as illustrated in connection with FIGS. 6 and 7. In an aspect, the transmissions may be performed by a transmission module of early decoding component 120, e.g., transmission module 1204/1304 in FIGS. 12-14.

The device may cease transmission of either the first PHY layer information or the second PHY layer information at 1014 after receiving an indication of early decoding from a receiver. For example, the device may be receiving a second packet of wireless communication during the time that it transmits the first and second PHY layer information. The device may cease transmission of the first or second PHY layer information after both receiving an indication of early decoding from a receiver and after decoding the second packet. Thus, transmission can be ceased when both UL and DL transmissions have been early decoded. This enables system capacity gains, because unnecessary transmissions do not occur. The second packet and the indication may be received via a reception module of early decoding component 120, e.g., receiving module 1208/1308 in FIGS. 12-14.

The transmitted information may comprise CS voice packets transmitted over an R99 dedicated channel. The information may be transmitted on a DTCH, the two consecutive transmissions each having a TTI of 10 ms, as illustrated in connection with FIG. 6.

Alternately, the information may be transmitted on a DCCH, the two consecutive transmissions each having a TTI of 20 ms, as illustrated in connection with FIG. 7.

In order to transmit the PHY layer information at 1010 and 1012, e.g., a voice frame generated at an audio codec may be processed at a MAC layer as a part of receiving the packet at 1002. Then, the first output and the duplicate output may be fed at 1008 from the MAC layer to the PHY layer during a duration that is twice the TTI of the PHY layer. The first output is then processed by a PHY layer as the first PHY layer information and the duplicate output is processed by the PHY layer as the second PHY layer information. In an aspect, the processing may be performed as part of a transmission function of early decoding component 120, e.g., by voice frame processor module 1206 in FIGS. 12 and 14.

FIG. 11 is a flow chart of a method 1100 of wireless communication. The method may be performed by a wireless communication receiving device, such as a UE or a Node B. At 1102, the receiving device receives first information in a first TTI. At 1104, the receiving device receives duplicate information in a second, consecutive TTI following the first TTI. The second information is a duplicate of the first PHY layer information. In an aspect, the reception may be performed via a reception module of early decoding component 120, e.g., receiving module 1208/1308 in FIGS. 12-14.

The first information may comprise first PHY layer information, and the second information may comprise duplicate PHY layer information. The first TTI and the second TTI each have a period ½ of a period at which a voice codec generates voice frames.

At 1106, the receiving device attempts to early decode the information in the first TTI. Thereafter, the receiving device attempts to decode the information in the second TTI at 1108, when the PHY layer information in the first TTI has not been successfully decoded. In an aspect, the decoding may be performed as part of a reception function of early decoding component 120, e.g., by decoding module 1310 in FIGS. 13 and 14.

The decoding module may be configured to cease decoding when the information is successfully decoded at 1110. Thus, the decoding may cease when either the first information or the second information is successfully decoded

The receiving device may transmit an indication at 1112 that the information has been successfully decoded prior to receiving the entire duplicate information. This enables a transmitter to cease transmission of unnecessary information, thereby providing system capacity gains. Additionally, the receiver may increase its own power consumption savings by powering down appropriate receiver subsystems from the time of successful early decoding until the end of the packet duration. In an aspect, the transmission may be performed via a transmission module of early decoding component 120, e.g., receiving module 1204/1304 in FIGS. 12-14.

The transmitted information may comprise CS voice packets transmitted over an R99 dedicated channel. The information may be transmitted on a DTCH, the two consecutive transmissions each having a TTI of 10 ms, as illustrated in connection with FIG. 6.

Alternately, the information may be transmitted on a DCCH, the two consecutive transmissions each having a TTI of 20 ms, as illustrated in connection with FIG. 7.

In order to avoid an increase in transmission power due to the reduced spreading factor, demodulation processing may be performed at the decoding module 1310 to soft combine symbols or a signal to interference ratio (SIR) target may be updated.

For example, as a part of attempting to decode the PHY layer information in the second TTI, as at 1108, the decoding module 1310 may soft combine symbols across the two consecutive TTIs at 1114 when the PHY layer information in the first TTI has not been successfully decoded.

The decoding module 1310 may also update a SIR target at 1116 when a packet has been decoded successfully or when a packet has not been decoded at the end of the second TTI. For example, when the packet decodes successfully, whether in the first TTI or the second TTI, the SIR target can be reduced by a fixed step size. The SIR target can be increased by a step size when the packet fails to decode in either of the two TTIs.

FIG. 12 is a conceptual data flow diagram 1200 illustrating the data flow between different modules/means/components in an exemplary apparatus 1202. The apparatus may a device transmitting wireless communication, e.g., either a UE or a Node B that transmits to a wireless communication receiver 1250.

The apparatus includes a receiving module 1208 that receives a packet at a media control layer. The apparatus includes a packet processor module 1206 that generates a first MAC layer output based on the received packet, generates at least one duplicate MAC layer output based on the received packet, and feeds the first MAC layer output and the duplicate MAC layer output to a PHY layer object.

The apparatus includes a transmission module 1204 that transmits, e.g., first PHY layer information based on the first MAC layer output in a first TTI and that begins a transmission of second PHY layer information based on the duplicate MAC layer output in a second, consecutive TTI following the first TTI. The second PHY layer information is a duplicate of the first PHY layer information. The first TTI and the second TTI may each have a period ½ of a period at which a voice codec generates voice frames.

The transmission module 1204 may be configured to transmit information comprising circuit switched voice packets. The transmission module 1204 may transmit over an R99 dedicated channel transmitted on a DTCH, the two consecutive transmissions each having a TTI of 10 ms or on a DCCH, the two consecutive transmissions each having a TTI of 20 ms.

The transmission module may be configured to cease transmission of the information after receiving an indication of early decoding from receiver 1250. The indication may be received at receiving module 1208.

The apparatus 1202 may further comprise a packet processor module 1206 that receives a packet at a MAC layer and that feeds a first output and a duplicate output from the MAC layer to the PHY layer, e.g., during a duration that is twice the TTI of the PHY layer. The first output may then be processed by a PHY layer as the first PHY layer information and the duplicate output may processed by the PHY layer as the second PHY layer information described in connection with FIG. 10.

FIG. 13 is a conceptual data flow diagram 1300 illustrating the data flow between different modules/means/components in an exemplary apparatus 1302. The apparatus may a device receiving wireless communication, e.g., either a UE or a Node B that receives transmissions from a wireless communication transmitting device.

The device includes a receiving module 1308 that receives first r information in a first TTI and that receives duplicate information in a second, consecutive TTI following the first TTI. The second information is a duplicate of the first information. The first information may comprise, e.g., first PHY layer information, and the second information may comprise, e.g., second, duplicate PHY layer information. The first TTI and the second TTI may each have a period one half of a period at which a voice codec generates voice frames. The apparatus includes a decoding module 1310 that attempts to early decode the information in the first TTI and that further attempts to decode the information in the second TTI, when the information in the first TTI has not been successfully decoded.

The received information may be circuit switched voice packets transmitted over an R99 dedicated channel. The information may be received on a DTCH, the two consecutive transmissions each having a TTI of 10 ms, or on a DCCH, the two consecutive transmissions each having a TTI of 20 ms.

The apparatus illustrated in example FIGS. 12 and 13 may include additional modules that perform any of the steps of the algorithm in the aforementioned flow chart of FIGS. 10 and 11. As such, any of the steps in the aforementioned flow charts of FIGS. 10 and 11 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

As illustrated in FIG. 14, a single apparatus may include both the modules for the reception functions of early decoding and the transmission functions of early decoding.

FIG. 14 is a diagram 1400 illustrating an example of a hardware implementation for an apparatus that includes aspects of 1202′/1302′ employing a processing system 1414. The processing system 1414 may be implemented with a bus architecture, represented generally by the bus 1424. The bus 1424 may include any number of interconnecting buses and bridges depending on the specific application of the processing system 1414 and the overall design constraints. The bus 1424 links together various circuits including one or more processors and/or hardware modules, represented by the processor 1404, the modules 1204/1304, 1206, 1208/1308, and 1310, and the computer-readable medium 1406. The bus 1424 may also link various other circuits such as timing sources, peripherals, voltage regulators, and power management circuits, which are well known in the art, and therefore, will not be described any further.

The processing system 1414 may be coupled to a transceiver 1410. The transceiver 1410 is coupled to one or more antennas 1420. The transceiver 1410 provides a means for communicating with various other apparatus over a transmission medium. The processing system 1414 includes a processor 1404 coupled to a computer-readable medium 1406. The processor 1404 is responsible for general processing, including the execution of software stored on the computer-readable medium 1406. The software, when executed by the processor 1404, causes the processing system 1414 to perform the various functions described supra for any particular apparatus. The computer-readable medium 1406 may also be used for storing data that is manipulated by the processor 1404 when executing software. The processing system further includes at least one of the modules 1204/1304, 1206, 1208/1308, and 1310. The modules may be software modules running in the processor 1404, resident/stored in the computer readable medium 1406, one or more hardware modules coupled to the processor 1404, or some combination thereof. If the apparatus is comprised in a Node B, the processing system 1414 may be a component of the Node B 410 and may include the memory 442 and/or at least one of the TX processor 420, the RX processor 438, and the controller/processor 440. If the apparatus is comprised in a UE, the processing system 1414 may be a component of the UE 450 and may include the memory 492 and/or at least one of the TX processor 480, the RX processor 470, and the controller/processor 490.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal In the alternative, the processor and the storage medium may reside as discrete components in a user terminal Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method of wireless communication, comprising:
receiving a packet at a media access control (MAC) layer object;
generating a first MAC layer output based on the received packet;
generating at least one duplicate MAC layer output based on the received packet; and
feeding the first MAC layer output and the duplicate MAC layer output to a physical (PHY) layer object.

2. The method of claim 1, further comprising:
transmitting first physical (PHY) layer information based on the first MAC layer output in a first transmission time interval (TTI);
beginning a transmission of second PHY layer information based on the duplicate MAC layer output in a second, consecutive TTI following the first TTI, the second PHY layer information being a duplicate of the first PHY layer information.

3. The method of claim 2, wherein the received packet comprises a voice packet, and wherein the first TTI and the second TTI each have a period ½ of a period at which a voice codec generates voice frames.

4. The method of claim 1, wherein the received packet comprises a voice packet, and the transmitted information comprises circuit switched voice packets transmitted over an R99 dedicated channel.

5. The method of claim 4, wherein the information is transmitted on a dedicated traffic channel, the two consecutive transmissions each having a TTI of 10 ms.

6. The method of claim 2, further comprising:
ceasing transmission of one of the first PHY layer information and the second PHY layer information after receiving an indication of early decoding from a receiver.

7. The method of claim 2, further comprising:
receiving a second packet of wireless communication;
ceasing transmission of one of the first PHY layer information and the second PHY layer information after both receiving an indication of early decoding from a receiver and decoding the second packet.

8. The method of claim 2, wherein the received packet comprises a voice frame, the method further comprising:
processing the voice frame at a MAC layer; and
feeding a first output and a duplicate output from the MAC layer to the PHY layer during a duration that is twice the TTI of the PHY layer, wherein the first output is processed by a PHY layer as the first PHY layer information and the duplicate output is processed by the PHY layer as the second PHY layer information.

9. The method of claim 1, wherein the information is transmitted on a dedicated control channel over two consecutive transmissions each having a TTI of 20 ms.

10. An apparatus for wireless communication, comprising:
a receiver configured to a receiver configured to receive a packet at a media access control (MAC) layer object;
a generator configured to generate a first MAC layer output based on the received packet and at least one duplicate MAC layer output based on the received packet and to feed the first MAC layer output and the duplicate MAC layer output to a physical (PHY) layer object.

11. The apparatus of claim 10, further comprising:
a transmitter configured to transmit first physical (PHY) layer information based on the first MAC layer output in a first transmission time interval (TTI) and to begin a transmission of second PHY layer information based on the duplicate MAC layer output in a second, consecutive TTI following the first TTI, the second PHY layer information being a duplicate of the first PHY layer information.

12. The apparatus of claim 11, wherein the received packet comprises a voice packet, and wherein the first TTI and the second TTI each have a period ½ of a period at which a voice codec generates voice frames.

13. The apparatus of claim 10, wherein the received packet comprises a voice packet, and the transmitted information comprises circuit switched voice packets transmitted over an R99 dedicated channel.

14. The apparatus of claim 13, wherein the information is transmitted on a dedicated traffic channel, the two consecutive transmissions each having a TTI of 10 ms.

15. The apparatus of claim 11, wherein the transmitter is configured to cease transmission of one of the first PHY layer information and the second PHY layer information after receiving an indication of early decoding from a receiver.

16. The apparatus of claim 11, wherein the receiver is further configured to receive a second packet of wireless communication, and wherein the transmitter is configured to cease transmission of one of the first PHY layer information and the second PHY layer information after both receiving an indication of early decoding from a receiver and decoding the second packet.

17. The apparatus of claim 11, wherein the received packet comprises a voice frame,
wherein the voice frame is processed at a MAC layer, and wherein a first output and a duplicate output are fed from the MAC layer to the PHY layer during a duration that is twice the TTI of the PHY layer, wherein the first output is processed by a PHY layer as the first PHY layer information and the duplicate output is processed by the PHY layer as the second PHY layer information.

18. The apparatus of claim 10, wherein the information is transmitted on a dedicated control channel over two consecutive transmissions each having a TTI of 20 ms.

19. An apparatus for wireless communication, comprising:
means for receiving a packet at a media access control (MAC) layer object;
means for generating a first MAC layer output based on the received packet;
means for generating at least one duplicate MAC layer output based on the received packet; and
means for feeding the first MAC layer output and the duplicate MAC layer output to a physical (PHY) layer object.

20. A computer program product, comprising:
a computer-readable medium comprising code for:
receiving a packet at a media access control (MAC) layer object;
generating a first MAC layer output based on the received packet;
generating at least one duplicate MAC layer output based on the received packet; and
feeding the first MAC layer output and the duplicate MAC layer output to a physical (PHY) layer object.

21. A method of wireless communication, comprising:
receiving first information in a first transmission time interval (TTI);
receiving duplicate information in a second, consecutive TTI;
attempting to early decode the information in the first TTI; and
attempting to decode the information in the second TTI, when the information in the first TTI has not been successfully decoded.

22. The method of claim 21, wherein the first information comprises first physical (PHY) layer information, and the duplicate information comprises second PHY layer information that is a duplicate of the first PHY layer information.

23. The method of claim 22, wherein the first TTI and the second TTI each have a period ½ of a period at which a voice codec generates voice frames.

24. The method of claim 22, wherein the received information comprises circuit switched voice packets transmitted over an R99 dedicated channel.

25. The method of claim 24, wherein the information is received on a dedicated traffic channel, the two consecutive transmissions each having a TTI of 10 ms.

26. The method of claim 22, further comprising:
soft combining symbols across the two consecutive TTIs when the PHY layer information in the first TTI has not been successfully decoded.

27. The method of claim 22, further comprising:
updating a signal to interference ratio (SIR) target when a packet has been decoded successfully or when a packet has not been decoded at the end of the second TTI.

28. The method of claim 27, wherein the SIR target is reduced by a fixed step size, when the PHY layer information is decoded successfully.

29. The method of claim 27, wherein the SIR target is increased by a step size, when the packet fails to decode in the first TTI and the second TTI.

30. The method of claim 21 wherein the information is received on a dedicated control channel, the two consecutive transmissions each having a TTI of 20 ms.

31. The method of claim 21, further comprising:
ceasing decoding when the either the first information or the second information is successfully decoded.

32. The method of claim 31, further comprising:
transmitting an indication that the information has been successfully decoded prior to receiving the entire duplicate information.

33. An apparatus for wireless communication, comprising:
a receiver configured to receive first information in a first transmission time interval (TTI) and to receive duplicate information in a second, consecutive TTI; and
a decoder configured to attempt to early decode the information in the first TTI and to attempt to decode the information in the second TTI, when the information in the first TTI has not been successfully decoded.

34. The apparatus of claim 33, wherein the first information comprises first physical (PHY) layer information, and the duplicate information comprises second PHY layer information that is a duplicate of the first PHY layer information.

35. The apparatus of claim 34, wherein the first TTI and the second TTI each have a period ½ of a period at which a voice codec generates voice frames.

36. The apparatus of claim 34, wherein the received information comprises circuit switched voice packets transmitted over an R99 dedicated channel.

37. The apparatus of claim 35, wherein the information is received on a dedicated traffic channel, the two consecutive transmissions each having a TTI of 10 ms.

38. The apparatus of claim 34, wherein the decoder is further configured to soft combine symbols across the two consecutive TTIs when the PHY layer information in the first TTI has not been successfully decoded.

39. The apparatus of claim 34, wherein the decoder is further configured to update a signal to interference ratio (SIR) target when a packet has been decoded successfully or when a packet has not been decoded at the end of the second TTI.

40. The apparatus of claim 39, wherein the SIR target is reduced by a fixed step size, when the PHY layer information is decoded successfully.

41. The apparatus of claim 39, wherein the SIR target is increased by a step size, when the packet fails to decode in the first TTI and the second TTI.

42. The apparatus of claim 33 wherein the information is received on a dedicated control channel, the two consecutive transmissions each having a TTI of 20 ms.

43. The apparatus of claim 33, wherein the decoder is configured to cease decoding when the either the first information or the second information is successfully decoded.

44. The apparatus of claim 43, wherein the transmitter is configured to transmit an indication that the information has been successfully decoded prior to receiving the entire duplicate information.

45. An apparatus for wireless communication, comprising:
means for receiving first information in a first transmission time interval (TTI);
means for receiving duplicate information in a second, consecutive TTI;
means for attempting to early decode the information in the first TTI; and
means for attempting to decode the information in the second TTI, when the information in the first TTI has not been successfully decoded.

46. A computer program product, comprising:
a computer-readable medium comprising code for:
receiving first information in a first transmission time interval (TTI);
receiving duplicate information in a second, consecutive TTI;
attempting to early decode the information in the first TTI; and
attempting to decode the information in the second TTI, when the information in the first TTI has not been successfully decoded.
